(19) United States
(12) Patent Application Publication
(10) Pub. No.: US 2021/0007300 A1
(43) Pub. Date: Jan. 14, 2021

(54) Soil Ecosystem Management and Intelligent Farming Arrangement

(71) Applicant: Alinda Chandra Mondal, Noranda, Westrn Australia (AU)

(72) Inventor: Alinda Chandra Mondal, Noranda, Westrn Australia (AU)

(21) Appl. No.: 16/979,934

(22) PCT Filed: Mar. 14, 2019
(86) PCT No.: PCT/AU2019/050231

§ 371 Date: Sep. 11, 2020

(30) Foreign Application Priority Data
Mar. 16, 2018 (AU) 2018900877

(51) Int. Cl. A01G 27/00; G06N 20/00

(52) U.S. Cl. CPC A01G 27/003; G06N 20/00; A01G 27/008

(57) ABSTRACT

An intelligent farming arrangement comprises a cultivation receptacles receiving a soil medium for cultivation of a plant. Each receptacle has a growth condition sensor for monitoring a condition of the soil medium in the receptacle. A leaching reservoir arranged below the receptacles receives leached nutrients from the receptacles gravity. A fluid redistribution arrangement having at least one fluid pump is arranged within the reservoir for redistributing such nutrients from the reservoir to the receptacles. A controller is in communication with each sensor and the fluid redistribution arrangement, the controller configured to operatively provide a GUI, via a communications network, to a user, the GUI having a prediction engine configured to predict plant growth in each receptacle by analysing the monitored soil condition, the GUI configured to display such predicted plant growth and monitored soil condition and to enable remote control of the fluid redistribution arrangement in real-time.

### CROSS-REFERENCE TO RELATED APPLICATIONS

This application is the national stage application of International Application No. PCT/AU2019/050231, filed Mar. 14, 2019, which designates the United States of America. This application also claims priority, under 35 U.S.C. § 119, to Australian Patent Application No. 2018900877, filed Mar. 16, 2018. The prior applications are herein incorporated by reference in their entirety.

### TECHNICAL FIELD

This invention relates broadly to the field of soil-based organism cultivation, and more particularly to an intelligent farming arrangement, a cultivation receptacle for an intelligent farming arrangement, and a soil ecosystem management arrangement.

### BACKGROUND ART

The following discussion of the background art is intended to facilitate an understanding of the present invention only. The discussion is not an acknowledgement or admission that any of the material referred to is or was part of the common general knowledge as at the priority date of the application.

In the art of natural ecosystem management, soil medium generally supports life of various kinds, ranging from microorganisms to plants. Such a soil medium generally harbours an ecosystem where various living organisms work together to create a balanced and naturally optimized living environment where life can survive and thrive. Due to commercial farming practices, this sensitive ecosystem has been greatly disturbed all around the world. Focus on overproduction of food to feed our growing population has led to overexploitation of the soil and its ecosystems. Large scale application of synthetic fertilizer and pesticide coupled with frequent drought disturbs the balance of life in the soil—reducing productivity in the long run.

Under the above circumstances, consumers are becoming gradually aware of the benefits of sustainable and organic living. For an example, organic farming directly depends on the nutrition level in the soil for productivity. Hence, organic farming requires proper monitoring and maintaining of soil health because if soil health is not properly maintained, then available nutrients for various soil-dependent living organisms reduce in availability which may lead to competition for nutrients and disturb the ecosystem in the soil. As a result, the living condition of living organisms deteriorates, productivity of the living organism decreases and survival becomes the key priority for these organisms.

In light of the above, Applicant has identified shortcomings in the art of soil management, where means is required to manage soil health which minimises soil degradation and erosion, to decrease pollution, and to maintain healthy soil ecosystem long-term. In addition, available materials and resources to be recycled to the greatest extent possible within the system, and to enhance the growth of various soil-based living organisms through a reduction of competition between such soil-based organisms utilising the same system and resources.

As a result, the current invention was conceived with these shortcomings in mind and in an attempt to ameliorate such shortcomings in the art of soil management and to facilitate a healthy soil ecosystem.

### SUMMARY OF THE INVENTION

It is to be understood that reference herein to a ‘GUI’ refers to a Graphical User Interface, being a user interface that allows a user to interact with an electronic device, such as a terminal, processing or computing system through manipulation of graphical icons, visual indicators, text-based typed command labels and/or text navigation, including primary and/or secondary notations, as is known in the art of computer science.

It is yet further to be appreciated that reference herein to ‘real-time’ is to be understood as meaning an instance of time that may include a delay typically resulting from processing, calculation and/or transmission times inherent in computer processing systems. These transmission and calculations times, albeit of generally small duration, do introduce some measurable delay, i.e. typically less than a second or within milliseconds, but the user is provided with relevant visualisation information relatively quickly or within substantial ‘real-time’.

According to a first aspect of the invention there is provided an intelligent farming arrangement comprising: a plurality of cultivation receptacles for receiving a soil medium therein for operative cultivation of a plant, with at least one growth condition sensor configured to operatively monitor a condition of the plant and/or soil medium; a leaching reservoir operatively arranged below said receptacles for receiving leached nutrients from said receptacles under the influence of gravity; a fluid redistribution arrangement having at least one fluid pump arranged within the leaching reservoir for redistributing such leached nutrients from the reservoir to the receptacles; and a controller arranged in signal communication with the growth condition sensor and the fluid redistribution arrangement, said controller configured to operatively provide a GUI, via a communications network, to a user, said GUI having a prediction engine configured to predict plant growth in each receptacle by analysing the monitored plant and/or soil condition, the GUI configured to display such predicted plant growth and monitored plant and/or soil condition and to enable remote control of the fluid redistribution arrangement in real-time.

Typically, the growth condition sensor is selected from a non-exhaustive group consisting of a moisture sensor configured for operatively monitoring a moisture content of the soil medium, a nutrient sensor configured for operatively monitoring a nutrient level of the soil medium, a plant condition sensor configured for operatively monitoring a condition of a plant growing in the soil medium, e.g. a camera, a pH sensor configured for operatively monitoring a pH level of the soil medium, and an environmental sensor configured for operatively monitoring an environmental characteristic proximate the soil medium, such as ambient light intensity, temperature, humidity, etc.

In an embodiment, the leaching reservoir is arranged subterranean with the cultivation receptacles supported over said reservoir by the terrain or substrate.

Typically, the fluid redistribution arrangement comprises suitable fluid conduits from the reservoir to the receptacles, as well as valves operable by the controller, and remotely via the GUI, to direct redistribution of leached nutrients as required.

Typically, the fluid redistribution arrangement comprises a fresh water supply for providing fresh water to the cultivation receptacles.

Typically, the prediction engine is configured to predict plant growth via a machine-learning algorithm configured to establish a predictive growth model compiled from the monitored plant and/or soil condition to generate a growth pattern over a period of time.

Typically, the prediction engine is configured to operatively perform machine learning on the monitored plant and/or soil condition by sensing a baseline environment and detecting, via the growth condition sensor, changing variables in such baseline environment over time to establish the predictive growth model indicative of a pattern of such changing variables.

Typically, the predictive growth model comprises a model based on detection theory principles wherein information-bearing patterns are differentiable from random patterns, the predicted plant growth comprising part of such information-bearing patterns.

Typically, the predictive growth model is established on information-bearing patterns consisting of a group selected from a soil condition, soil nutrient level, a plant condition, plant volume, plant height, soil pH level, soil moisture level, and environmental characteristic proximate the soil medium.

In one embodiment, the controller is configured to control the fluid redistribution arrangement according to the predictive growth model.

Typically, the farming arrangement comprises an energising assembly configured to harvest energy from an environment proximate said arrangement and to store such harvested energy for operatively energising the controller, fluid redistribution arrangement and growth condition sensors.

In an embodiment, the energising assembly comprises photovoltaic panels arranged to shade the cultivation receptacles as required.

According to a second aspect of the invention there is provided a cultivation receptacle for an intelligent farming arrangement, said receptacle comprising: a growth condition sensor for operatively monitoring a condition of a plant and/or soil medium in the receptacle; a leaching reservoir operatively arranged at a bottom portion of said receptacle for receiving leached nutrients from the receptacle under the influence of gravity; a fluid redistribution arrangement having a fluid pump arranged within the leaching reservoir for redistributing such leached nutrients from the reservoir to the soil; and a controller arranged in signal communication with the growth condition sensor and the fluid redistribution arrangement, said controller configured to operatively provide a GUI, via a communications network, to a user, said GUI having a prediction engine configured to predict plant growth in the receptacle by analysing the monitored plant and/or soil condition, the GUI configured to display such predicted plant growth and monitored plant and/or soil condition and to enable remote control of the fluid redistribution arrangement in real-time.

Typically, the growth condition sensor is selected from a non-exhaustive group consisting of a moisture sensor configured for operatively monitoring a moisture content of the soil medium, a nutrient sensor configured for operatively monitoring a nutrient level of the soil medium, a plant condition sensor configured for operatively monitoring a condition of a plant growing in the soil medium, a pH sensor configured for operatively monitoring a pH level of the soil medium, and an environmental sensor configured for operatively monitoring an environmental characteristic proximate the soil medium, such as ambient light intensity, temperature, etc.

Typically, the prediction engine is configured to predict plant growth via a machine-learning algorithm configured to establish a predictive growth model compiled from the monitored plant and/or soil condition to generate a growth pattern over a period of time.

Typically, the prediction engine is configured to operatively perform machine learning on the monitored plant and/or soil condition by sensing a baseline environment and detecting, via the growth condition sensor, changing variables in such baseline environment over time to establish the predictive growth model indicative of a pattern of such changing variables.

Typically, the predictive growth model comprises a model based on detection theory principles wherein information-bearing patterns are differentiable from random patterns, the predicted plant growth comprising part of such information-bearing patterns.

Typically, the predictive growth model is established on information-bearing patterns consisting of a group selected from a soil condition, soil nutrient level, a plant condition, plant volume, plant height, soil pH level, soil moisture level, and environmental characteristic proximate the soil medium.

Typically, the fluid redistribution arrangement comprises a fresh water supply for providing fresh water to the soil medium.

Typically, the prediction engine comprises a machine-learning algorithm configured to track plant growth data compiled from the monitored soil condition to generate a growth pattern over a period of time, said generated growth pattern indicative of predicted plant growth.

In one embodiment, the controller is configured to control the fluid redistribution arrangement according to the predictive growth model.

According to a third aspect of the invention there is provided a soil ecosystem management arrangement comprising: an enclosure configured to at least partially enclose and minimise an ingress of environmental aspects into a volume; a plurality of cultivation receptacles operatively arranged within said volume, each receptacle for receiving a soil medium therein for operative cultivation of an organism; a fluid reticulation arranged in fluid communication with each receptacle, said fluid reticulation configured to supply said receptacles with fluid and to collect excess fluid therefrom for subsequent redistribution; at least one moisture sensor configured for operatively monitoring a moisture content of soil medium; at least one nutrient sensor configured for operatively monitoring a nutrient level of the soil medium and/or fluid in the fluid reticulation; an energising assembly configured to harvest energy from an environment proximate said enclosure and to store such harvested energy; and a controller arranged in communication with the fluid reticulation, the moisture sensor and the nutrient sensor and configured to automatically control the fluid reticulation to control moisture content and/or nutrient level of the soil medium, the controller operatively energised by the energising assembly, said controller further configured to operatively provide a GUI, via a communications network, to a user, said GUI having a prediction engine configured to predict plant growth in the receptacle by analysing the moisture content and/or nutrient level of the soil medium, the GUI configured to display such predicted plant growth and moisture content and/or nutrient level of the soil medium to enable remote control of the fluid redistribution arrangement in real-time.

Typically, the enclosure is configured to minimise an ingress of environmental aspects into the volume by comprising and/or including a cover, a netting, etc.

In an embodiment, the enclosure comprises or includes an anti-virus net or netting.

In an embodiment, the enclosure includes an electrochromic film to regulate an amount of sunlight entering the enclosure.

Typically, the controller includes an ambient light sensor and is configured to automatically control said electrochromic film according to sensed light.

Typically, the fluid reticulation includes an irrigation outlet for each receptacle whereby fluid is suppliable to said receptacle.

Typically, the fluid reticulation includes a fluid reservoir for storing fluid.

Typically, the fluid reticulation includes one insoluble particle filter for filtering insoluble particles therefrom.

Typically, the fluid reticulation includes at least one fluid pump for circulating fluid therethrough.

Typically, the arrangement includes a plurality of moisture sensors configured to operatively monitor a moisture content of soil medium in a plurality of receptacles.

Typically, the controller is configured to control operation of the energising assembly.

In an embodiment, the controller is configured to monitor operating characteristics of the enclosure, the fluid reticulation, and/or the energising assembly.

Accordingly, in an embodiment, the controller includes at least one camera configured to capture an image or video of at least one receptacle.

Similarly, in one embodiment, the controller includes an environment sensor, such as temperature, humidity, etc., for sensing environmental operating characteristics inside the volume.

Typically, the controller is configured to automatically control the moisture content of the soil medium by including a user-configurable lookup table of sensed moisture content and receptacle fluid supply requirements.

In an embodiment, the controller includes a transceiver configured to transmit and receive signals. The transceiver may include a wired and/or wireless transceiver.

In an embodiment, the controller is configured to receive an instruction signal which instructs the controller in a manner of controlling the electrochromic film of the enclosure, the fluid reticulation, and/or the energising assembly.

### BRIEF DESCRIPTION OF THE DRAWINGS

The description will be made with reference to the accompanying drawings in which:

FIGS. 1A and 1B are diagrammatic representations of embodiments of an intelligent farming arrangement, in accordance with an aspect of the invention;

FIG. 2 is a diagrammatic representation of an embodiment of a cultivation receptacle for an intelligent farming arrangement, in accordance with an aspect of the invention; and

FIGS. 3A and 3B are diagrammatic perspective-view representations of embodiments of a soil ecosystem management arrangement, in accordance with a broad aspect of the invention.

### DETAILED DESCRIPTION OF EMBODIMENTS

Further features of the present invention are more fully described in the following description of several non-limiting embodiments thereof. This description is included solely for the purposes of exemplifying the present invention to the skilled addressee. It should not be understood as a restriction on the broad summary, disclosure or description of the invention as set out above. In the figures, incorporated to illustrate features of the example embodiment or embodiments, like reference numerals are used to identify like parts throughout.

The present invention broadly proposes means to maintain a soil ecosystem which minimises soil degradation and erosion, decreases pollution, and maintains long-term soil fertility. In addition, desirable organism cultivation means will also enable available materials and resources to be recycled to the greatest extent possible within the system, and to enhance the growth of various soil-based living organisms through a reduction of competition between such soil-based organisms utilising the same system and resources. Importantly, the present invention incorporates predictive computer algorithms whereby optimum soil conditions can be maintained for plant cultivation, based on sensing a variety of parameters, including soil conditions and environmental factors, as well as actual monitored plant growth.

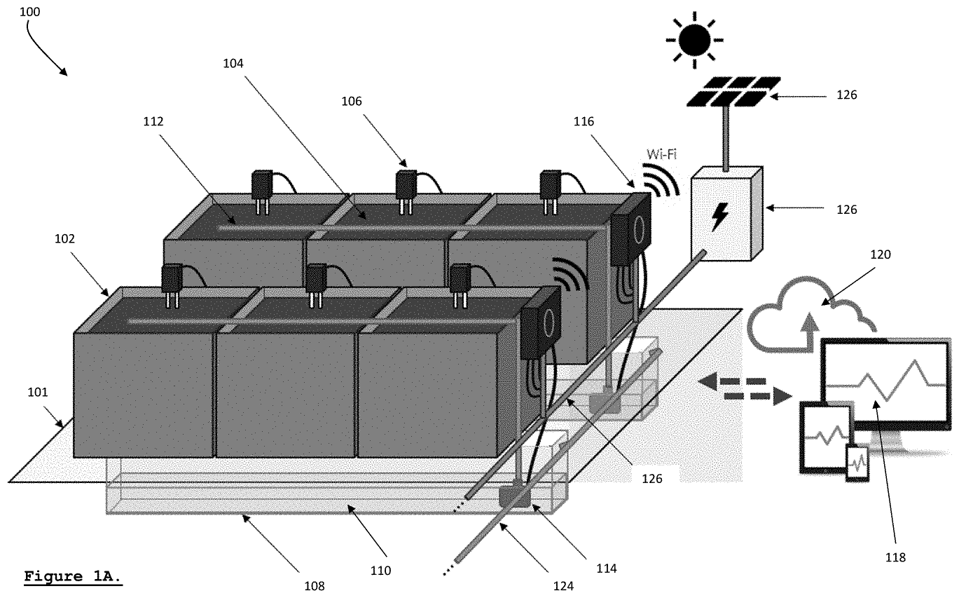

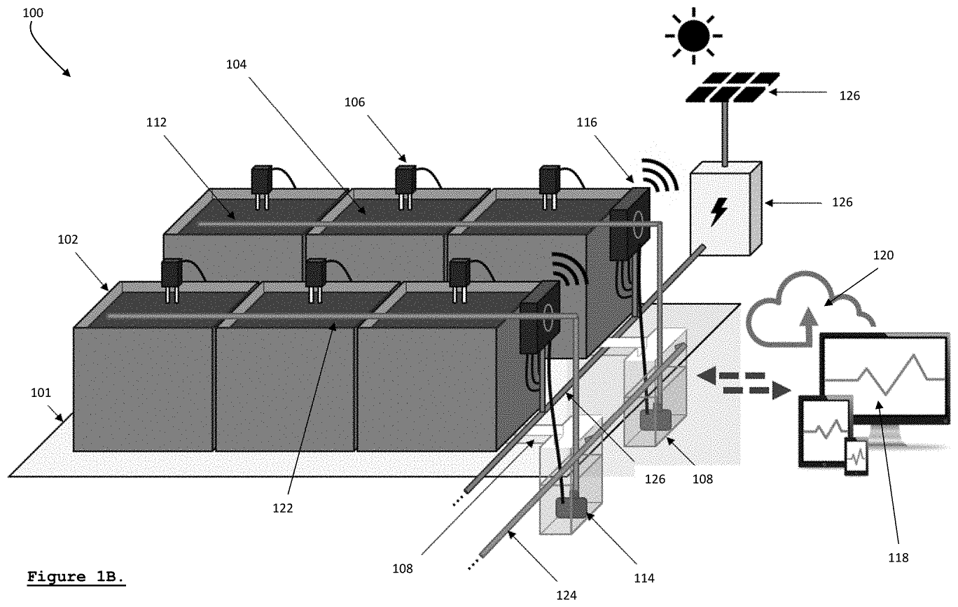

With reference now to FIG. 1 of the accompanying drawings, there is broadly shown embodiments of an intelligent farming arrangement 100 which comprises a plurality of cultivation receptacles 102 for receiving a soil medium 104 therein for operative cultivation of a plant. Each receptacle 102 has a growth condition sensor 106 for operatively monitoring a condition of a plant (not shown) and/or the soil medium 104 in the receptacle 102.

Arrangement 100 also includes a leaching reservoir 108 which is operatively arranged below said receptacles 102, as shown, for receiving leached nutrients 110 from said receptacles 102 under the influence of gravity. Further included is a fluid redistribution arrangement 112 having at least one fluid pump 114 arranged within the leaching reservoir 108 for redistributing such leached nutrients 110 from the reservoir 108 to the receptacles 102.

Also included is a controller 116 arranged in signal communication with each growth condition sensor 106 and the fluid redistribution arrangement 112, the controller 116 configured to operatively provide a GUI 118, via a communications network 120, to a user. The GUI 118 has a prediction engine configured to predict plant growth in each receptacle 102 by analysing the monitored plant and/or soil condition. The GUI 118 is also configured to display such predicted plant growth and monitored soil condition and to enable remote control of the fluid redistribution arrangement 112 in real-time via the network 120.

The skilled addressee will appreciate that communications network 120 may take a variety of forms, such as a cloud-based system which can comprise the Internet and associated enabling networks, including mobile phone networks, radio and other wireless networks, cabled infrastructure and processing systems, as is known in the art. In such a manner, GUI 118 and remote control of the arrangement 100 can be facilitated from any suitable location worldwide.

The growth condition sensor 106 can include a moisture sensor for monitoring a moisture content of the soil medium 104, a nutrient sensor for monitoring a nutrient level of the soil medium 104, a plant condition sensor for monitoring a condition of a plant growing in the soil medium 104, e.g. a camera, a pH sensor for monitoring a pH level of the soil medium 104, an environmental sensor for monitoring an environmental characteristic proximate the soil medium, such as ambient light intensity, temperature, etc., or the like. The skilled addressee will appreciate that a variety of sensor types are relevant and within the scope of the present invention. In this manner, the soil, environmental and plant conditions can be monitored by the broad growth condition sensor 106.

The leaching reservoir 108 is arranged subterranean with the cultivation receptacles 102 supported over said reservoir by the terrain or substrate 101, as shown. The fluid redistribution arrangement 112 comprises suitable fluid conduits 122 from the reservoir 108 to the receptacles 102, as well as valves operable by the controller 116, and remotely via the GUI 118, to direct redistribution of leached nutrients 110 as required. The fluid redistribution arrangement 112 also comprises a fresh water supply 124 for providing fresh water to the cultivation receptacles 102, as needed.

Typically, the prediction engine is configured to predict plant growth via a machine-learning algorithm configured to establish a predictive growth model compiled from the monitored plant and/or soil condition to generate a growth pattern over a period of time. The prediction engine is typically configured to operatively perform machine learning on the monitored plant and/or soil condition by sensing a baseline environment and detecting, via the growth condition sensor, changing variables in such baseline environment over time to establish the predictive growth model indicative of a pattern of such changing variables. Typically, the predictive growth model is established on information-bearing patterns consisting of a group selected from a soil condition, soil nutrient level, a plant condition, plant volume, plant height, soil pH level, soil moisture level, and environmental characteristic proximate the soil medium.

For example, as will be appreciated by the skilled addressee, the following is a text-based example of a plant health algorithm based on current soil, water and other environmental parameters:

=== Run information ===

| | |
|---|---|
| Scheme: | weka.classifiers.trees.PandomTree −K 0 −M 1.0 −V |

| | |
|---|---|
| 0.001 −S 1 | |
| Relation: | ESA_TEST- |
| weka.filters.unsupervised.attribure.Remove-R1- | |
| weka.fiiters.unsupervised.attribute.Remove-R7 | |

| | |
|---|---|
| Instances: | 10 |
| Attributes: | |
| | Temp |
| | Solar-Index |
| | Moisture |
| | Fertility |
| | Temp-5 |
| | Solar-Index-5 |
| | Plant-Growth-5 |
| Test mode: | evaluate on training data |

=== Classifier model (full training set) ===
RandomTree
==========
Temp < 16.85

| \| | Temp < 16.25 | |
|---|---|---|
| \| | \| | Moisture < 34 : NO GROWTH (1/0) |
| \| | \| | Moisture >= 34 : POSITIVE GROWTH (1/0) |

| | |
|---|---|
| \| | Temp >= 16.25 : POSITIVE GROWTH (2/0) |

Temp >= 16.85

| \| | Fertility < 210 : NO GROWTH (1/0) | | | |
|---|---|---|---|---|
| \| | Fertility >= 210 | | | |
| \| | \| | Moisture < 39 | | |
| \| | \| | \| | Solar-Index < 4.8 : POSITIVE GROWTH (1/0) | |
| \| | \| | \| | Solar-Index >= 4.8 | |
| \| | \| | \| | \| | Fertility < 227 : POSITIVE GROWTH (1/0) |
| \| | \| | \| | \| | Fertility >= 227 : NO GROWTH (2/0) |

| | | |
|---|---|---|
| \| | \| | Moisture >= 39 : POSITIVE GROWTH (1/0) |

Size of the tree : 15
Time taken to build model: 0 seconds
=== Evaluation on training set ===
Time taken to test model on training data: 0 seconds
=== Summary ===

| | | |
|---|---|---|
| Correctly | | Classified |
| Instances 10 | 100 % | |
| Incorrectly Classifed Instances | 0 | 0 % |
| Kappa statistic | 1 | |
| Mean absolute error | 0 | |
| Root mean squared error | 0 | |
| Relative absolute error | 0 % | |
| Root relative squared error | 0 % | |
| Total Number of Instances | 10 | |

=== Detailed Accuracy By Class ===

| | | | | | | | | |
|---|---|---|---|---|---|---|---|---|
| TP | FP | | | F- | MC | ROC | PRC | |
| Rate | Rate | Precision | Recall | Measure | C | Area | Area | Class |
| 1 | 0 | 1 | 1 | 1 | 1 | 1 | 1 | POSITIVE |
| | | | | | | | | GROWTH |
| 1 | 0 | 1 | 1 | 1 | 1 | 1 | 1 | NO GROWTH |
| 1 | 0 | 1 | 1 | 1 | 1 | 1 | 1 | Weighted |
| | | | | | | | | Avg. |

=== Confusion Matrix ===
a b <-- classified as
6 0 | a = POSITIVE GROWTH
0 4 | b = NO GROWTH

The controller is typically configured to automatically control the fluid redistribution arrangement 112 according to the predictive growth model. For example, the prediction engine may be configured to track a root volume of a plant by measuring the average overnight soil-water retention over a period of time, e.g. a few days, and compare such root volume with other monitored soil conditions, e.g. soil moisture content, nutrient level, ambient light intensity, etc., in order to generate a suitable predictive growth model.

Similarly, other plant growth aspects can be monitored to track plant growth data along with monitored soil conditions. For example, stereoscopic cameras along with suitable machine-vision may be implemented to track plant volume, a suitable biomass sensor may be used, numerous environmental factors can be measured, along with soil conditions. In such a manner, the predictive growth model may be generated which indicates which aspects are more beneficial for plant growth, which in turn allows predictive control of such aspects to promote plant growth by use of appropriate machine learning algorithms. The skilled addressee will appreciate that such ‘machine learning’ generally refers to the application and/or use of algorithms and statistical models by a processor or processing system (such as controller 116 and/or a cloud-based processor via network 120) to effectively perform a specific task without using explicit instructions, but rather via reliance on patterns and inference. As described, such patterns are typically established via tracked plant growth data compiled from the monitored plant and/or soil condition to generate a predictive growth model over a period of time.

The farming arrangement 100 also generally comprises an energising assembly 126 which is configured to harvest energy from an environment proximate said arrangement 100 and to store such harvested energy for operatively energising the controller 116, fluid redistribution arrangement 112 and growth condition sensors 106. In the exemplified embodiment, the energising assembly 126 comprises photovoltaic panels arranged to shade the cultivation receptacles as required.

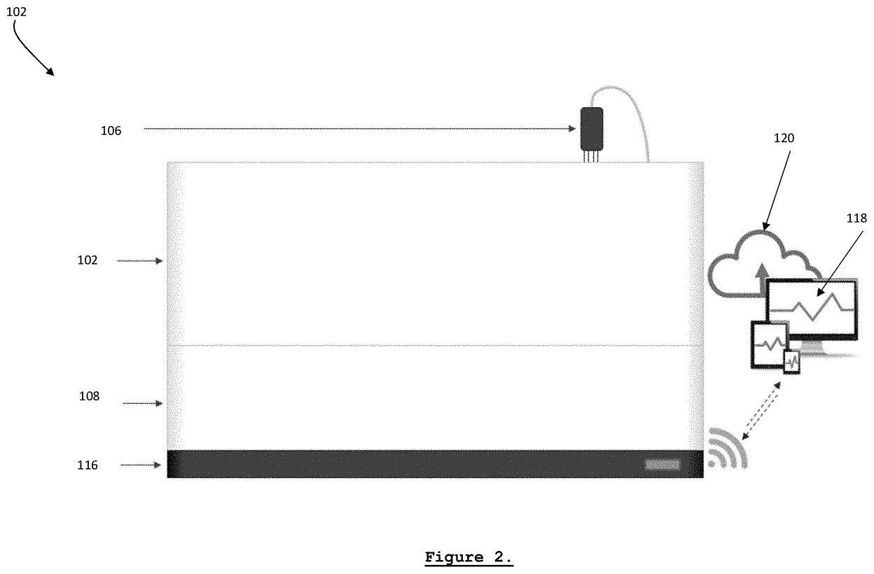

The present invention also includes an associated cultivation receptacle 102 for such a nutrient recycling farming arrangement 100, as shown in FIG. 2. Such a free-standing receptacle 102 may have an integrated unitary controller 116 having a broadband cellular network modem (such as 3G, 4G) to allow remote operation via a mobile phone network 120, a wi-fi transceiver, a radio transmitter, and/or the like.

Such a receptacle 102 may find particular application in an urban application, as plant cultivation can be facilitated in a more-modern setting where mobile phone usage is ubiquitous. For example, plants can be cultivated in receptacle 102 with plant growth monitorable via GUI 118, along with machine-learning principles to ensure optimum growth and soil conditions are maintained, all whilst being able to monitor (and control, to some extent) plant growth from a mobile phone or tablet, or the like.

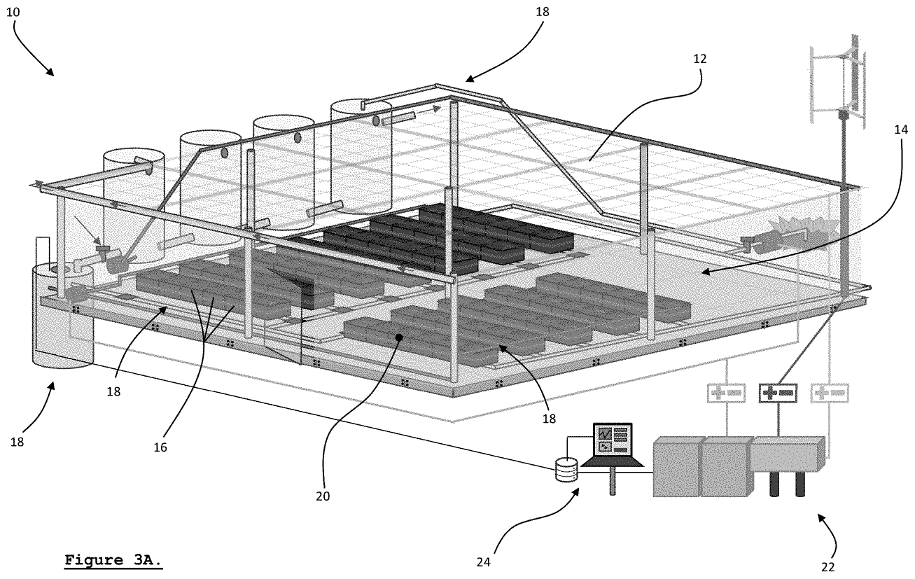

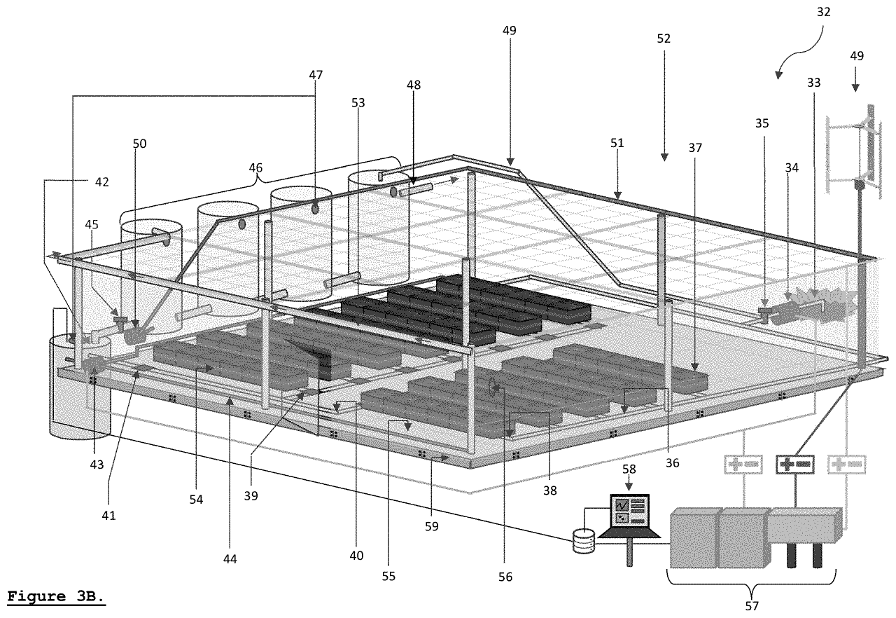

FIG. 3 shows broad embodiments of a soil ecosystem management arrangement 10, in accordance with one aspect of the invention. Arrangement 10 can comprise an embodiment of arrangement 100 described above, including a number of receptacles 102, or the like. In general, the arrangement 10 typically includes an enclosure 12, cultivation receptacles 16, a fluid reticulation 18, at least one moisture sensor 20, an energising assembly 22, and a controller 24, as broadly indicated in FIG. 1. The cultivation arrangement 10 is configured to provide an automated and self-contained means for, for example, plant or fungi cultivation, as described in more detail below.

The skilled addressee will appreciate that arrangement 10 is useable for the cultivation of any suitable organism, with the embodiments described herein generally used for plant, fungi and associated soil-based organism cultivation. It is to be appreciated that reference herein to an ‘organism’ includes reference to a microorganism, fungi and/or a plant, and generally includes reference to any suitable form of life considered as an entity, including a plant, a fungus, a protistan, a moneran, and/or the like. Similarly, although reference herein is generally made to plant cultivation, the cultivation of any organism is apposite, as will be appreciated by the skilled addressee.

The enclosure 12 is typically configured to at least partially enclose and minimise an ingress of environmental aspects into volume 14. The enclosure 12 is configured to minimise an ingress of environmental aspects into the volume by including a cover, a netting, shielding, or the like, where the environmental aspects typically include wind, rain, dust, sunlight, and pests such as insects and rodents, as will be appreciated by the skilled addressee.

The arrangement 10 also includes a plurality of cultivation receptacles 16 operatively arranged within the volume 14. Each receptacle 16 is typically configured for receiving a soil medium therein for operative separate cultivation of an organism. Each cultivation receptacle 12 typically defines a fluid drainage aperture, as described in more detail below, for arranging the receptacle 16 in fluid communication with the fluid reticulation 18 whereby excess fluid is collectible.

The arrangement 10 further includes fluid reticulation 18 which is arranged in fluid communication with each receptacle 16. The fluid reticulation 18 is generally configured to supply the receptacles 16 with fluid and to collect excess fluid therefrom for subsequent redistribution. It is to be appreciated that the fluid may include water, nutrients and/or other suitable fluids useful to maintain a healthy soil ecosystem.

The fluid reticulation 18 generally includes an irrigation outlet for each receptacle 16 whereby fluid is suppliable to said receptacle. The fluid reticulation 18 generally also includes a drainage conduit under each receptacle 16 whereby excess fluid is collected from said receptacle. Additionally, the fluid reticulation 18 typically includes a fluid reservoir(s) for storing fluid. In an embodiment, the fluid reticulation 18 may also include an external water supply, such as irrigation liquid source 33 described in more detail below.

The fluid reticulation 18 also typically includes one insoluble particle filter for filtering insoluble particles therefrom, as well as at least one fluid pump for circulating fluid therethrough, as described in more detail below. The arrangement 10 generally includes at least one moisture sensor 20 which is configured for operatively monitoring a moisture content of soil medium in one or more receptacles 16. Typically, the arrangement 10 includes a plurality of moisture sensors 20 configured to operatively monitor a moisture content of the soil medium in a plurality of receptacles 16.

The arrangement 10 further incorporates the energising assembly 22 which is configured to harvest energy from an environment proximate the enclosure 12 and to store such harvested energy. In different embodiments, the energising assembly 22 may be configured to harvest energy consisting of wind energy, solar energy, hydro energy, and/or geothermal energy. Accordingly, the energising assembly 22 may include a photovoltaic cell, a wind turbine, a hydroelectricity turbine, and/or a geothermal turbine, as detailed below. The energising assembly 22 generally includes at least one electrochemical cell, or a collection of such cells to form a battery, for storing harvested energy. Such harvesting and storage systems are well-known in the art and will not be described in detail herein.

Importantly, the arrangement 10 includes controller 24 arranged in communication with the fluid reticulation 18 and the moisture sensor 20, as shown. The controller 24 is configured to automatically control the moisture content of the soil medium and is operatively energised by the energising assembly 22. The controller 24 is also generally configured to control operation of the energising assembly 22.

The skilled addressee will appreciate that the controller 24 may comprise any suitable processor or microcontroller configured to receive input, perform logical and arithmetical operations on a suitable instruction set, and provide output, as well as transitory and/or non-transitory electronic storage, as is well-known in the art of controllers. As such, the controller 24 is typically configured to monitor operating characteristics of the arrangement 10, including the enclosure 12, the fluid reticulation 18, and/or the energising assembly 22.

In an embodiment, the controller 24 includes at least one camera configured to capture an image or a video of at least one receptacle 16, e.g. a still camera, a video camera, etc. The camera may also be displaceable on user input, i.e. pan-tilt-zoom (PTZ) functionality, or be mounted on a rail system or robot or drone, etc. Similarly, in different embodiments, the controller 24 includes at least one nutrient sensor configured to monitor a nutrient level of soil medium and/or of fluid in the fluid reticulation, and/or an environment sensor, such as temperature, humidity, etc., for sensing environmental operating characteristics inside the volume 14, etc.

In one embodiment, the controller 24 is configured to automatically control the moisture content of the soil medium by including a user-configurable lookup table of sensed moisture content and receptacle fluid supply requirements, or the like. Similarly, the controller 24 may be configured with similar instructions for controlling operation of the arrangement 10, including the enclosure 12, the fluid reticulation 18, and/or the energising assembly 22.

In an embodiment, the controller 24 includes a transceiver configured to transmit and receive signals. The transceiver may include a wired and/or wireless transceiver. In an embodiment, the controller 24 is configured to transmit a log of the monitored operating characteristics. In one embodiment, the controller 24 is configured to receive an instruction signal which instructs the controller 24 in a manner of controlling the enclosure 12, e.g. an electrochromic film of the enclosure 12, as described below, the fluid reticulation 18, and/or the energising assembly 22.

For example, the controller 24 may be configured to receive instruction from a suitably configured interface, such as a graphical user interface or GUI, as is well-known in the art, including a web-enabled interface, or the like. In this manner, a user can remotely monitor and control the cultivation of plants in the arrangement 10.

Referring now to FIG. 3B of the accompanying drawings, there is shown a more-detailed view of arrangement 10 (now indicated by reference numeral 32) for enhancing the growth of soil-based living organism through partitioning soil medium and recycling leached soil microbe produced inorganic nutrients (such as ionic salts and minerals).

In this embodiment, the arrangement 32 comprises multiple rows of receptacles 37, wherein each receptacle 37 is configured to receive and contain a soil medium to culture soil based living organisms, at least one aperture (not shown) in the floor of each receptacle 37 to allow excess irrigation liquid to drain from the receptacle, a support member 55 to separate the receptacles from the local soil medium, and a horizontally expandable primary drainage conduit 38 integrated in the support member 55 in fluid communication with the aperture of receptacle 37 to collect excess irrigation liquid with leached nutrients.

Arrangement 32 also includes a primary filter 39 in fluid communication with the drainage conduit 38 to filter the loose soil particles in the excess irrigation liquid, a horizontally expandable secondary drainage conduit 40 integrated in the support member 55 in fluid communication with the primary filter 39, and a secondary filter 41 in fluid communication with the secondary drainage conduit 40 to filter the remaining loose soil particles from the excess irrigation liquid.

The arrangement 32 further comprises at least one main fluid storage reservoir 42 in fluid communication with the secondary filter 41 for storing the excess irrigation liquid with leached nutrients, at least one additional fluid storage reservoir 46 connected to the main fluid storage reservoir 42 to store extra irrigation liquid, a pump 43 to transfer the irrigation liquid from the main fluid storage reservoir 42 to the horizontally extendable liquid distribution means 44 to distribute water evenly in the receptacle 37, and at least an air vent 47 in the main and additional fluid storage reservoir to aerate the stored liquid.

The arrangement 32 may further comprise a transparent or semitransparent system cover 52 made from material such as transparent solar panels or building integrated photovoltaic panels (BIPV) to protect the soil ecosystem in the receptacles from harsh climatic conditions such as scorching sunlight, hailstorm, etc. A water drainage conduit 53 is included to collect liquid above the system cover 52 to transfer the liquid to the secondary fluid storage reservoir 46, a pump 50 to transfer liquid from the secondary fluid storage reservoir 46 into the liquid distribution means 51 to supply liquid on top of the system cover 52 for cleaning purpose, and a switch 35 connected to the pump 34 to regulate the water flow from the irrigation liquid source 33 wherein the switch could transfer the irrigation liquid to the conduit 49 to top up liquid in the additional fluid storage reservoir 46 or transfer the irrigation liquid to the conduit 36 to top up liquid in the main fluid storage reservoir 42.

The arrangement 32 may further comprise an electric system 57 to store electricity and fulfil the electricity requirement for the arrangement 32 with the electric system being supplied with electricity from the solar cells in the system cover 52 and possibly a wind turbine 49, a control panel to regulate activities in the arrangement 32 such as monitoring the fluid quality in main fluid storage reservoir 42, running or monitoring the electrical system.

The operating procedure of the arrangement 32 comprises irrigation liquid being pumped from the fluid storage reservoir to the liquid distribution means to hydrate the soil in the receptacles. The excess irrigation liquid with leached nutrients (such as ionic salts and minerals) come out of the receptacle through the aperture following complete hydration of the soil to enter the drainage conduit. The common drainage conduit carries the excess irrigation water with leached nutrients from multiple receptacles into a removable particle filter to filter the loose soil particles in excess irrigation liquid. The filtered liquid with soluble leached nutrients then enters the fluid storage reservoir. The fluid storage reservoir is topped up with additional irrigation liquid as required. The irrigation liquid is pumped from the fluid storage reservoir to the liquid distribution means at an appropriate time again to hydrate the dehydrate or semi dehydrate soil.

The arrangement 32 additionally collects the liquid on the system cover 52 such as rain water to store in the additional fluid storage reservoir 46. This liquid could be transfer to the system cover 52 through liquid distribution means 51 using pump 50 to clean the system cover 52 as required. The liquid then travels back to the additional fluid storage reservoir 46 through drainage conduit 53.

The system cover 52 of arrangement 32 may have an electrochromic film attached to the bottom of the cover which could be used to regulate the sun light falling in the area holding the receptacles 37 to ensure that the soil medium in the receptacle is receiving optimum amount of sun light to maintain a healthy ecosystem of living organisms in the soil medium. Typically, the controller includes an ambient light sensor and is configured to automatically control said electrochromic film according to sensed light.

The electricity required to run the pump(s) and other electrical equipment is preferably generated from renewable sources of energy such as solar or wind power, as described above. In one embodiment, a secondary barrier such as pesticide patches 54 may line the external wall of the receptacles as demonstrated in FIG. 2 to ensure that the external living organisms can't crawl into the receptacles. The arrangement 32 could additionally have a cover 56(such as an anti-virus net) to surround the system to act as an additional barrier for the external living organisms.

Applicant believes is particularly advantageous that the present invention provides means to maintain a soil ecosystem to minimize soil degradation and erosion, decrease pollution, maintain long-term soil fertility, recycle materials and resource to the greatest extent possible to enhance the growth of various soil-based living organisms—through reducing competition between soil-based living organisms by partitioning the soil medium and preserving soil microbe produced inorganic nutrients. In addition, by the application of intelligent control methodologies and machine-learning principles, plant growth can be predicted and managed, all whilst allowing remote monitoring and control via a GUI which can be accessed from almost anywhere via a suitable network.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth. In the example embodiments, well-known processes, well-known device structures, and well-known technologies are not described in detail, as such will be readily understood by the skilled addressee.

The use of the terms “a”, “an”, “said”, “the”, and/or similar referents in the context of describing various embodiments (especially in the context of the claimed subject matter) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. As used herein, the term “and/or” includes any and all combinations of one or more of the associated listed items.

It is to be appreciated that reference to “one example” or “an example” of the invention, or similar exemplary language (e.g., “such as”) herein, is not made in an exclusive sense. Various substantially and specifically practical and useful exemplary embodiments of the claimed subject matter are described herein, textually and/or graphically, for carrying out the claimed subject matter.

Accordingly, one example may exemplify certain aspects of the invention, whilst other aspects are exemplified in a different example. Variations (e.g. modifications and/or enhancements) of one or more embodiments described herein might become apparent to those of ordinary skill in the art upon reading this application. The inventor(s) expects skilled artisans to employ such variations as appropriate, and the inventor(s) intends for the claimed subject matter to be practiced other than as specifically described herein.

1. An intelligent farming arrangement comprising:
a plurality of cultivation receptacles for receiving a soil medium therein for operative cultivation of a plant, with at least one growth condition sensor configured to operatively monitor a condition of the plant and/or soil medium;
a leaching reservoir operatively arranged below said receptacles for receiving leached nutrients from said receptacles under the influence of gravity;
a fluid redistribution arrangement having at least one fluid pump arranged within the leaching reservoir for redistributing such leached nutrients from the reservoir to the receptacles; and
a controller arranged in signal communication with the growth condition sensor and the fluid redistribution arrangement, said controller configured to operatively provide a GUI, via a communications network, to a user, said GUI having a prediction engine configured to predict plant growth in each receptacle by analysing the monitored plant and/or soil condition, the prediction engine configured to predict plan growth via a machine-learning algorithm configured to establish a predictive growth model compiled from the monitored plant and/or soil condition to generate a predicted growth pattern over a period of time, the GUI configured to display such predicted plant growth and monitored plant and/or soil condition and to enable remote control of the fluid redistribution arrangement in real-time and/or the controller is configured to control the fluid redistribution arrangement according to the predictive growth model.

2. The arrangement of claim 1, wherein the growth condition sensor is selected from a non-exhaustive group consisting of a moisture sensor configured for operatively monitoring a moisture content of the soil medium, a nutrient sensor configured for operatively monitoring a nutrient level of the soil medium, a plant condition sensor configured for operatively monitoring a condition of a plant growing in the soil medium, a pH sensor configured for operatively monitoring a pH level of the soil medium, and an environmental sensor configured for operatively monitoring an environmental characteristic proximate the soil medium.

3. The arrangement of claim 1, wherein the leaching reservoir is arranged subterranean with the cultivation receptacles supported over said reservoir by the terrain or substrate.

4. The arrangement of claim 1, wherein the fluid redistribution arrangement comprises suitable fluid conduits from the reservoir to the receptacles, as well as valves operable by the controller, and remotely via the GUI, to direct redistribution of leached nutrients as required.

5. The arrangement of claim 1, wherein the fluid redistribution arrangement comprises a fresh water supply for providing fresh water to the cultivation receptacles.

6. (canceled)

7. The arrangement of claim 1, wherein the prediction engine is configured to operatively perform machine learning on the monitored plant and/or soil condition by sensing a baseline environment and detecting, via the growth condition sensor, changing variables in such baseline environment over time to establish the predictive growth model indicative of a pattern of such changing variables.

8. The arrangement of claim 1, wherein the predictive growth model comprises a model based on detection theory principles wherein information-bearing patterns are differentiable from random patterns, the predicted plant growth comprising part of such information-bearing patterns.

9. The arrangement of claim 1, wherein the predictive growth model is established on information-bearing patterns consisting of a group selected from a soil condition, soil nutrient level, a plant condition, plant volume, plant height, soil pH level, soil moisture level, and environmental characteristic proximate the soil medium.

10. (canceled)

11. The arrangement of claim 1, wherein the farming arrangement comprises an energising assembly configured to harvest energy from an environment proximate said arrangement and to store such harvested energy for operatively energising the controller, fluid redistribution arrangement and growth condition sensor.

12. The arrangement of claim 11, wherein the energising assembly comprises photovoltaic panels arranged to shade the cultivation receptacles as required.

13. A cultivation receptacle for an intelligent farming arrangement, said receptacle comprising:
a growth condition sensor for operatively monitoring a condition of a plant and/or soil medium in the receptacle;
a leaching reservoir operatively arranged at a bottom portion of said receptacle for receiving leached nutrients from the receptacle under the influence of gravity;
a fluid redistribution arrangement having a fluid pump arranged within the leaching reservoir for redistributing such leached nutrients from the reservoir to the soil medium; and
a controller arranged in signal communication with the growth condition sensor and the fluid redistribution arrangement, said controller configured to operatively provide a GUI, via a communications network, to a user, said GUI having a prediction engine configured to predict plant growth in the receptacle by analysing the monitored plant and/or soil condition, the prediction engine configured to predict plant growth via a machine-learning algorithm configured to establish a predictive growth model compiled from the monitored plant and/or soil condition to generate a predicted growth pattern over a period of time, the GUI configured to display such predicted plant growth and monitored plant and/or soil condition and to enable remote control of the fluid redistribution arrangement in real-time and/or the controller is configured to control the fluid redistribution arrangement according to the predictive growth model.

14. The receptacle of claim 13, wherein the growth condition sensor is selected from a group consisting of a moisture sensor configured for operatively monitoring a moisture content of the soil medium, a nutrient sensor configured for operatively monitoring a nutrient level of the soil medium, a plant condition sensor configured for operatively monitoring a condition of a plant growing in the soil medium, a pH sensor configured for operatively monitoring a pH level of the soil medium, and an environmental sensor configured for operatively monitoring an environmental characteristic proximate the soil medium.

15. (canceled)

16. The receptacle of claim 13, wherein the prediction engine is configured to operatively perform machine learning on the monitored plant and/or soil condition by sensing a baseline environment and detecting, via the growth condition sensor, changing variables in such baseline environment over time to establish the predictive growth model indicative of a pattern of such changing variables.

17. The receptacle of claim 13, wherein the predictive growth model comprises a model based on detection theory principles wherein information-bearing patterns are differentiable from random patterns, the predicted plant growth comprising part of such information-bearing patterns.

18. The receptacle of claim 13, wherein the predictive growth model is established on information-bearing patterns consisting of a group selected from a soil condition, soil nutrient level, a plant condition, plant volume, plant height, soil pH level, soil moisture level, and environmental characteristic proximate the soil medium.

19. (canceled)

20. A soil ecosystem management arrangement comprising:
an enclosure configured to at least partially enclose and minimise an ingress of environmental aspects into a volume;
a plurality of cultivation receptacles operatively arranged within said volume, each receptacle for receiving a soil medium therein for operative cultivation of an organism;
a fluid reticulation arranged in fluid communication with each receptacle, said fluid reticulation configured to supply said receptacles with fluid and to collect excess fluid therefrom for subsequent redistribution;
at least one moisture sensor configured for operatively monitoring a moisture content of soil medium;
at least one nutrient sensor configured for operatively monitoring a nutrient level of the soil medium and/or fluid in the fluid reticulation;
an energising assembly configured to harvest energy from an environment proximate said enclosure and to store such harvested energy; and
a controller arranged in communication with the fluid reticulation, the moisture sensor and the nutrient sensor and configured to automatically control the fluid reticulation to control moisture content and/or nutrient level of the soil medium, the controller operatively energised by the energising assembly, said controller further configured to operatively provide a GUI, via a communications network, to a user, said GUI having a prediction engine configured to predict plant growth in a receptacle by analysing the moisture content and/or nutrient level of the soil medium, the prediction engine configured to predict plant growth via a machine-learning algorithm configured to establish a predictive growth model compiled from the monitored plant and/or soil condition to generate a predicted growth pattern over a period of time, the GUI configured to display such predicted plant growth and moisture content and/or nutrient level of the soil medium to enable remote control of the fluid reticulation in real-time and/or the controller is configured to control the fluid redistribution arrangement according to the predictive growth model.

21. The arrangement of claim 20, wherein the enclosure includes an electrochromic film to regulate an amount of sunlight entering the enclosure, the controller having an ambient light sensor and configured to automatically control said electrochromic film according to sensed light.
